(19) United States
(12) Patent Application Publication
(10) Pub. No.: US 2008/0104036 A1
(43) Pub. Date: May 1, 2008

(54) MOBILE PHONE CAPABLE OF BUILDING A QUICK LAUNCH ITEM ACCORDING A SEARCH RESULT AND RELATED METHOD

(75) Inventor: Hsien-Chung Lin, Hsinchu County (TW)

Correspondence Address: NORTH AMERICA INTELLECTUAL PROPERTY CORPORATION, P.O. BOX 506, MERRIFIELD, VA, 22116, US

(73) Assignees: QISDA CORPORATION, Gueishan Hsiang (TW); BENQ CORPORATION, Taipei (TW)

(21) Appl. No.: 11/876,771

(22) Filed: Oct. 22, 2007

(30) Foreign Application Priority Data
Oct. 25, 2006 (TW) 095139338

(51) Int. Cl. G06F 17/30

(52) U.S. Cl. 707/3; 707/E17.014

(57) ABSTRACT

A mobile phone includes a memory module for storing an index table and a search database, an input interface for inputting a search datum and a quick launch datum, a search unit stored in the memory module for searching function items corresponding to the search datum in the search database, a quick launch setting unit stored in the memory for setting a quick launch item for a function item of the function items searched by the search unit according to the quick launch datum by looking up names of the function items in the search database, a display module for displaying the names of the function items searched by the search unit and the quick launch item, and a processor for executing a program corresponding to the quick launch item when selecting the quick launch item by the input interface.

### BACKGROUND OF THE INVENTION

1. Field of the Invention

The present invention relates to a mobile phone capable of building a quick launch item according a search result and a related method, and more particularly, to a mobile phone capable searching all function items and of building a quick launch item according a search result and a quick launch datum provided by a user and a related method.

2. Description of the Prior Art

In highly developed information communication systems in the modern information society, electronic devices are widely utilized in every area. For instance, the utilization of a convenient and lightweight mobile phone device has become a way of communication in our daily life; users can easily exchange and share information, experience, and opinion through the convenience of the mobile phone device. The mobile phone progressed tremendously in recent years and various types of mobile phones are continuously developed. The increasing utilization has created a demand in production, as the mobile phones are becoming common causing the technology of mobile phones to mature with the trend moving towards smaller multi-functional phones. The important issue now is how to design a more convenient mobile phone for the user to utilize.

There are multiple function items in a conventional mobile phone. The function items are arranged in a menu of a tree structure by attribution. The user has to select a function item by entering the menu layer upon layer with a keypad. It is inconvenient for searching a function item in the menu with multiple layers. Generally some function items in common use are predetermined to be built in a quick launch menu of the conventional mobile phone so that the user can select the predetermined function items easily. However it is impossible to list all function items and nodes of functional categories in the quick launch menu and the user cannot build a quick launch menu optionally in the conventional mobile phone.

### SUMMARY OF THE INVENTION

It is therefore a primary objective of the claimed invention to provide a mobile phone capable of building a quick launch item according a search result and a related method for solving the above-mentioned problem.

According to the claimed invention, a mobile phone includes a housing, a memory module installed inside the housing for storing an index table having addresses of all function items and for storing a search database having names of the part function items, an input interface installed on the housing for inputting a search datum and a quick launch datum, a search unit stored in the memory module for searching function items corresponding to the search datum in the search database, a quick launch setting unit stored in the memory module for setting a quick launch item for a function item of the function items searched by the search unit according to the quick launch datum by looking up the function item in the index table, a display module installed on the housing for displaying names of the function items searched by the search unit and the quick launch item, and a processor installed inside the housing and electrically connected to the memory module and the input interface for executing a program corresponding to the quick launch item when selecting the quick launch item by the input interface.

According to the claimed invention, a method for setting a quick launch item for a function item according to a search result of the function items in a mobile phone is disclosed. The method includes (a) building a search database according to an index table having addresses of all function items, the search database having names of the part function items; (b) storing the search database in the mobile phone; (c) inputting a search datum in the mobile phone; (d) searching function items corresponding to the search datum in the search database; (e) inputting a quick launch datum in the mobile phone; and (f) setting a quick launch item for a function item of the function items searched in step (d) according to the quick launch datum by looking up the function item in the index table.

According to the claimed invention, a method for setting a quick launch item for an electronic device is disclosed. The electronic device includes a plurality of function items in an index table. The function items are corresponding to a first language. The method includes: (a) building a search database according to the index table and the first language with a sort method, the index table including addresses of the plurality of function items, the search database including parts of the plurality of function items; (b) storing the search database in the electronic device; (c) inputting a search datum in the electronic device; (d) searching function items corresponding to the search datum in the search database; and (e) setting the quick launch item for one of the function items searched in step (d).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a mobile phone according to a preferred embodiment of the present invention.

FIG. 2 is a flowchart of utilizing the mobile phone to search the function items and to build the quick launch item according to a search result according to the preferred embodiment of the present invention.

FIG. 3 is a diagram of a display module displaying the function items searched by a search unit and the quick launch item according to the preferred embodiment of the present invention.

### DETAILED DESCRIPTION

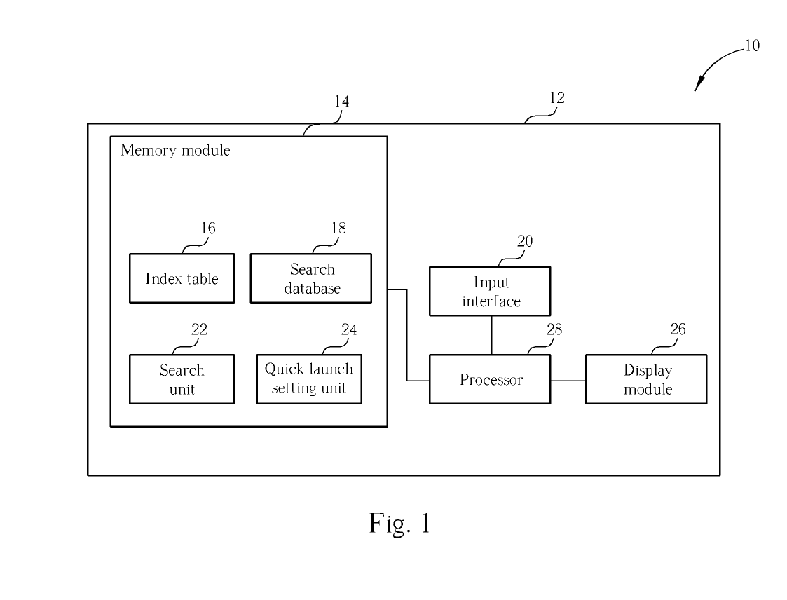

Please refer to FIG. 1. FIG. 1 is a functional block diagram of a mobile phone 10 according to a preferred embodiment of the present invention. The mobile phone 10 can be substituted for other electronic devices, such as a GPS handset, a PDA, a MP3 player, and so on. The mobile phone 10 includes a housing 12, a memory module 14 installed inside the housing 12 for storing an index table 16 having addresses of all function items and for storing a search database 18 having names of the part function items. The search database can be built according to the index table 16. The mobile phone 10 further includes an input interface 20 installed on the housing 12 for inputting a search datum and a quick launch datum. The input interface 20 can be a keypad. The mobile phone 10 further includes a search unit 22 stored in the memory module 14 for searching function items corresponding to the search datum in the search database 18. The search unit 22 can be a search program. The mobile phone 10 further includes a quick launch setting unit 24 stored in the memory module 14 for setting a quick launch item for a function item of the function items searched by the search unit 22 according to the quick launch datum input by the input interface 20 by looking up the function item in the index table 16. The mobile phone 10 further includes a display module 26 installed on the housing 12 for displaying names of the function items searched by the search unit 22 and the quick launch item, and a processor 28 installed inside the housing 12 and electrically connected to the memory module 14, the input interface 20, and the display module 26 for controlling operation of the mobile phone 10, such as executing a program corresponding to the quick launch item when selecting the quick launch item by the input interface 20.

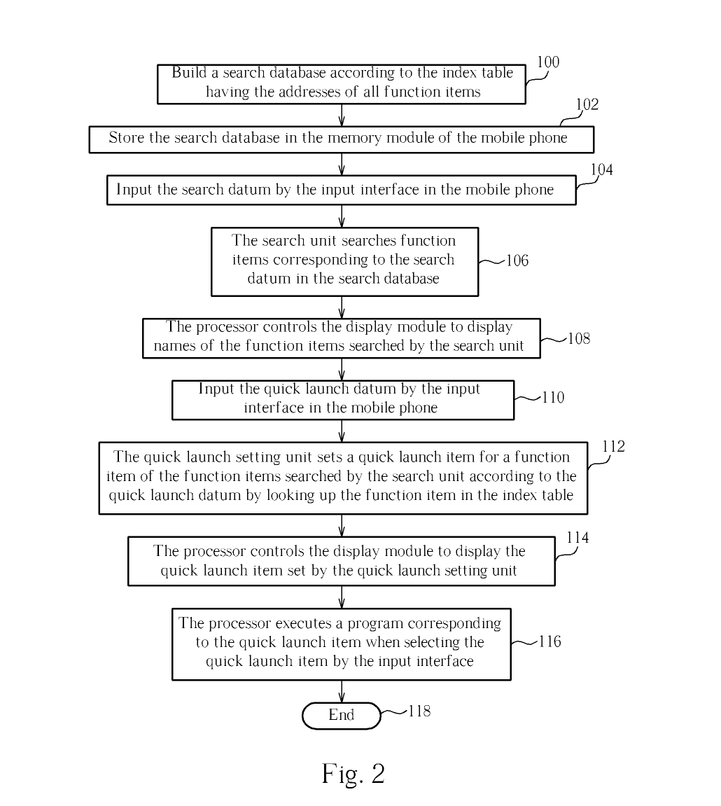

Please refer to FIG. 2. FIG. 2 is a flowchart of utilizing the mobile phone 10 to search the function items and to build the quick launch item according to a search result according to the preferred embodiment of the present invention. The method includes following steps:

Step 100: Build a search database 18 according to the index table 16 having the addresses of all function items. The search database 18 includes the names of the part function items.

Step 102: Store the search database 18 in the memory module 14 of the mobile phone 10.

Step 104: Input the search datum by the input interface 20 in the mobile phone 10.

Step 106: The search unit 22 searches function items corresponding to the search datum in the search database 18.

Step 108: The processor 28 controls the display module 26 to display names of the function items searched by the search unit 22.

Step 110: Input the quick launch datum by the input interface 20 in the mobile phone 10.

Step 112: The quick launch setting unit 24 sets a quick launch item for a function item of the function items searched by the search unit 22 according to the quick launch datum by looking up the function item in the index table 16.

Step 114: The processor 28 controls the display module 26 to display the quick launch item set by the quick launch setting unit 24.

Step 116: The processor 28 executes a program corresponding to the quick launch item when selecting the quick launch item by the input interface 20.

Step 118: End.

More detailed descriptions for the steps mentioned above will be provided. In the current infrastructure of the mobile phone, the memory module 14 of the mobile phone 10 stores the index table 16 having the addresses of all function items. The index table 16 includes token data corresponding to the names of the function items and index values corresponding to addresses of the token data. Each toke datum and the corresponding index value correspond with a function item. For example, a token datum of a function item “Time Setting” can be set as “TXT_TIME_SETTING”, and a corresponding index value corresponds to an address of the function item “Time Setting” located in a function menu of a tree structure, as an index value for accessing the function menu of the tree structure. The search database 18 can be built according to the index table 16 and a language. The search database includes a plurality of the token data and reassembled index values corresponding to the language and the token data. Each toke datum and the corresponding reassembled index value correspond with a function item. Not every function item is listed to be a search object, such as the function items “Open” or “Edit” not indicating to a specific function. The index table 16 indicates all functions of the mobile phones 10, but the search database 18 indicates part functions of the mobile phone 10 which needs to be searched. In addition, every word and number has its own language setting. For increasing search efficiency, function items of each language can be sorted according to a corresponding sort method. For different languages, the mobile phone 10 includes corresponding search databases 18. The token data sorted with different sort methods correspond with different reassembled index values. Each toke datum and the corresponding reassembled index value correspond with a function item. The token data of the search database 18 can be sorted according to the reassembled index values with a radix sort method or an AVL tree method. For example, if the language of the function items is English, the token data can be sorted with the English alphabet A-Z in sequence. The token datum with a prefix “A” is sorted in front, and the token datum with a prefix “Z” is sorted at the back with the radix sort method. If the language of the function items is Chinese, the token data named in Chinese can be translated into English so that the token data named in English can be sorted with the English alphabet A-Z in sequence. For example, the Chinese name can be transformed into the English name with Chinese Romanization method. The sequence of the token data is recorded in the reassembled index values for reducing memory. Afterwards, the search database 18 is stored in the memory module 14 of the mobile phone 10.

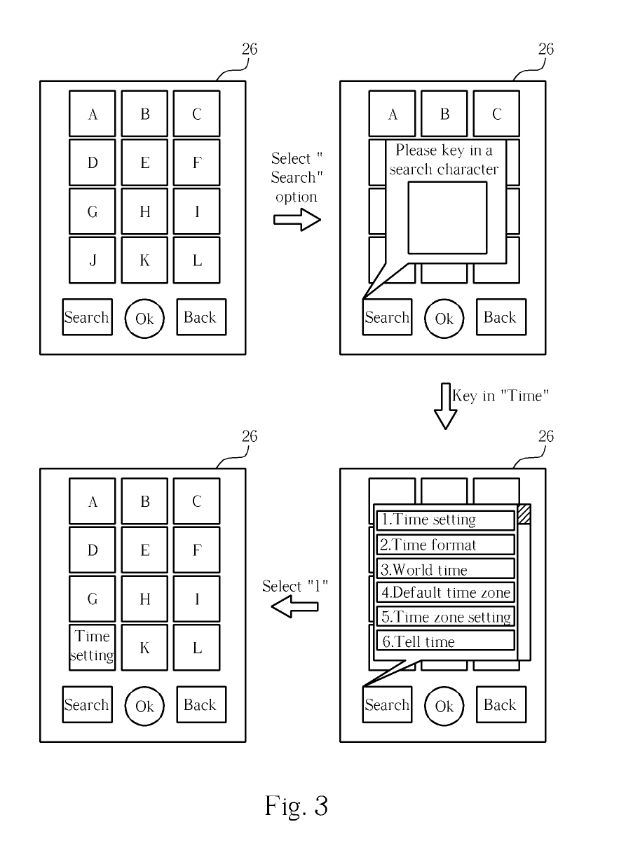

The user can input the search datum by the input interface 20 in the mobile phone 10. For example, please refer to FIG. 3. FIG. 3 is a diagram of the display module 26 displaying the function items searched by the search unit 22 and the quick launch item according to the preferred embodiment of the present invention. The user can select a search function by the input interface 20, then the display module 26 pops up a window for providing the user to key in a search character or word. As shown is FIG. 3, when the user keys in a word “Time”, the search unit 22 can search function items corresponding to the word “Time” in the search database 18 stored in the memory module 14. The search unit can search names of the function items corresponding to the search datum in the search database 18 with a binary search method for increasing search efficiency and reducing search time. The search unit 22 searches function items in the search database 18 according to the language selected by the user. The processor 28 controls the display module 26 to display the names of the function items searched by the search unit 22, such as “Time Setting”, “Time Format”, “World Time”, “Default Time Zone”, “Time Zone Setting”, “Tell Time”, and so on. Then the user can input the quick launch datum by the input interface 20 in the mobile phone 10. As shown in FIG. 3, the user inputs the quick launch datum “1” for selecting the function item “Time Setting”, so the quick launch setting unit 24 sets the quick launch item for the function item “Time Setting”. The processor 28 controls the display module 26 to display an icon of the quick launch item “Time Setting” replacing an original icon of “J”. The processor 28 executes a program corresponding to “Time Setting” when the user selects the quick launch item “Time Setting” by the input interface 20. In FIG. 3, the icons “A” to “Z” are the predetermined quick launch items, and the icons “J” to “L” are the new quick launch items generated according to the present invention. The newest quick launch item can replace the oldest quick launch item circulating in a sequence of “J” to “L” due to limited number of the quick launch items.

In contrast to the prior art, the mobile phone of the present invention can set a quick launch item for a function item according to a search result of the function items. It is convenient of the user to search the function items in common use easily, and the searched function items can be built as the quick launch items for selecting repeatedly and quickly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A mobile phone comprising:
a housing;
a memory module installed inside the housing for storing an index table comprising addresses of all function items and for storing a search database comprising names of the part function items;
an input interface installed on the housing for inputting a search datum and a quick launch datum;
a search unit stored in the memory module for searching function items corresponding to the search datum in the search database;
a quick launch setting unit stored in the memory module for setting a quick launch item for a function item of the function items searched by the search unit according to the quick launch datum by looking up the function item in the index table;
a display module installed on the housing for displaying names of the function items searched by the search unit and the quick launch item; and
a processor installed inside the housing and electrically connected to the memory module and the input interface for executing a program corresponding to the quick launch item when selecting the quick launch item by the input interface.

2. The mobile phone of claim 1 wherein the index table comprises token data corresponding to the names of the function items and index values corresponding to addresses of the token data.

3. The mobile phone of claim 2 wherein the search database comprises the token data and reassembled index values corresponding to a language and the token data.

4. The mobile phone of claim 3 wherein the token data of the search database are sorted according to the reassembled index values with a radix sort method.

5. The mobile phone of claim 3 wherein the token data of the search database are sorted according to the reassembled index values with an AVL tree method.

6. The mobile phone of claim 1 wherein the search unit searches names of the function items corresponding to the search datum in the search database with a binary search method.

7. The mobile phone of claim 1 wherein the input interface is a keypad.

8. A method for setting a quick launch item for a function item according to a search result of the function items in a mobile phone, the method comprising:
(a) building a search database according to an index table comprising addresses of all function items, the search database comprising names of the part function items;
(b) storing the search database in the mobile phone;
(c) inputting a search datum in the mobile phone;
(d) searching function items corresponding to the search datum in the search database; (e) inputting a quick launch datum in the mobile phone; and
(f) setting a quick launch item for a function item of the function items searched in step (d) according to the quick launch datum by looking up the function item in the index table.

9. The method of claim of 8 wherein the index table comprises token data corresponding to the names of the function items and index values corresponding to addresses of the token data.

10. The method of claim of 9 wherein step (a) comprises building the search database according to the index table and a language and the search database comprises the token data and reassembled index values corresponding to the language and the token data.

11. The method of claim of 10 further comprising sorting the token data of the search database according to the reassembled index values with a radix sort method.

12. The method of claim of 10 further comprising sorting the token data of the search database according to the reassembled index values with an AVL tree method.

13. The method of claim of 8 wherein step (d) comprises searching names of the function items corresponding to the search datum in the search database with a binary search method.

14. The method of claim of 8 further comprising displaying names of the function items searched in step (d) and the quick launch item.

15. The method of claim of 8 further comprising executing a program corresponding to the quick launch item when selecting the quick launch item.

16. A method for setting a quick launch item for an electronic device, the electronic device comprising a plurality of function items in an index table, the function items being corresponding to a first language, the method comprising:
(a) building a search database according to the index table and the first language with a sort method, the index table comprising addresses of the plurality of function items, the search database comprising at least one of the plurality of function items;
(b) storing the search database in the electronic device;
(c) inputting a search datum in the electronic device;
(d) searching function items corresponding to the search datum in the search database; and
(e) setting the quick launch item for one of the function items searched in step (d).

17. The method of claim of 16 wherein the index table comprises token data corresponding to names of the plurality of function items and index values corresponding to addresses of the token data, the step (a) further comprises reassembling the index values to build the search database and the search database comprises the reassembled index values and the token data corresponding to the reassembled index values.

18. The method of claim of 16 wherein the function items are corresponding to a second language and the step (a) further comprises transforming the second language into the first language.

19. The method of claim of 16 wherein the sort method comprises a radix sort method or an AVL tree method.
